(19) United States
(12) Patent Application Publication
(10) Pub. No.: US 2022/0364356 A1
(43) Pub. Date: Nov. 17, 2022

(54) SYSTEMS, METHODS AND MACHINE READABLE PROGRAMS FOR MEASURING, RECORDING, AND ACCESSING DATA FOR IMPROVED SELECTION OF CLOTHING

(71) Applicant: Robert William Pollack, Yonkers, NY (US)

(72) Inventor: Robert William Pollack, Yonkers, NY (US)

(21) Appl. No.: 17/830,322

(22) Filed: Jun. 1, 2022

Related U.S. Application Data
(63) Continuation of application No. 16/521,246, filed on Jul. 24, 2019, now abandoned.
Application No. 16/521,246 is a continuation of application No. 16/952,020, filed on Nov. 18, 2020.
Application No. 16/521,246 is a continuation of application No. 15/673,651, filed on Aug. 10, 2017, now abandoned.
Application No. 15/673,651 is a continuation of application No. 15/157,749, filed on May 18, 2016, now abandoned.
Application No. 15/157,749 is a continuation of application No. 14/731,103, filed on Jun. 4, 2015, now abandoned.
(60) Provisional application No. 62/023,218, filed on Jul. 11, 2014.
(60) Provisional application No. 62/035,099, filed on Aug. 8, 2014.
(60) Provisional application No. 62/112,157, filed on Feb. 4, 2015.
(60) Provisional application No. 62/118,881, filed on Feb. 20, 2015.

(51) Int. Cl. E04B 1/76; E04D 13/17; E04D 13/16; E04F 17/04; E04F 17/02; E04F 17/00; E04D 12/00; E04B 2/74; E04B 7/00; E04B 2/00

(52) U.S. Cl. CPC E04B 1/7662; E04D 13/17; E04D 13/1625; E04F 17/04; E04F 17/02; E04F 17/00; E04D 12/002; E04B 2/7457; E04B 7/00; E04B 2/00; E04D 13/172; E04B 1/7612; E04B 1/7076

(57) ABSTRACT

The present disclosure provides a variety of approaches to facilitate the remote fitting of clothing items.

### COPYRIGHT NOTICE

A portion of the disclosure of this patent document contains material which is subject to copyright protection. The copyright owner has no objection to the reproduction by anyone of the patent document or patent disclosure as it appears in the Patent and Trademark Office, patent file or records, but otherwise reserves all copyrights whatsoever.

### CROSS-REFERENCE TO RELATED APPLICATIONS

This patent application is a continuation of and claims the benefit of priority to Ser. No. 16/952,020, filed Nov. 18, 2020, which is a continuation of and claims the benefit of priority to Ser. No. 16/521,246, filed Jul. 24, 2019, which is a continuation of and claims the benefit of priority to U.S. patent application Ser. No. 15/673,651, filed Aug. 10, 2017, which in turn is a continuation of and claims the benefit of priority to U.S. patent application Ser. No. 15/157,749, filed May 18, 2016, which in turn is a continuation of and claims the benefit of priority to U.S. patent application Ser. No. 14/731,103, filed Jun. 4, 2015, which in turn is a continuation in part of and claims the benefit of priority to U.S. patent application Ser. No. 14/317,904, filed Jul. 28, 2014, which in turn is a continuation in part of and claims the benefit of priority to U.S. patent application Ser. No. 14/023,429, filed Sep. 10, 2013, which in turn is a continuation in part of and claims the benefit of priority to U.S. patent application Ser. No. 13/633,866, filed Oct. 2, 2012, which in turn is a continuation of and claims the benefit of priority to U.S. patent application Ser. No. 13/101,334, filed May 5, 2011, which in turn is a continuation-in-part of and claims the benefit of priority to U.S. patent application Ser. No. 12/788,132, filed May 26, 2010, which in turn is a continuation-in-part of and claims the benefit of priority to U.S. patent application Ser. No. 12/649,946, filed Dec. 30, 2009 and issued Sep. 7, 2010 as U.S. Pat. No. 7,788,868, which is a continuation of and claims the benefit of priority to U.S. patent application Ser. No. 12/139,442, filed Jun. 13, 2008 and issued Feb. 12, 2010 as U.S. Pat. No. 7,654,051, which is a continuation-in-part of and claims the benefit of priority to U.S. patent application Ser. No. 11/203,354, filed Aug. 12, 2005 and issued Dec. 2, 2008 as U.S. Pat. No. 7,458,189, which in turn claims the benefit of priority of U.S. Provisional Patent Application Ser. No. 60/634,823, filed Dec. 9, 2004.

This patent application is a continuation of and claims the benefit of priority to Ser. No. 16/952,020, filed Nov. 18, 2020, which is a continuation of and claims the benefit of priority to Ser. No. 16/521,246, filed Jul. 24, 2019, which is a continuation of and claims the benefit of priority to U.S. patent application Ser. No. 15/673,651, filed Aug. 10, 2017, which in turn is a continuation of and claims the benefit of priority to U.S. patent application Ser. No. 15/157,749, filed May 18, 2016, which in turn is a continuation of and claims the benefit of priority to U.S. patent application Ser. No. 14/731,103, filed Jun. 4, 2015, which in turn is a continuation in part of and claims the benefit of priority to U.S. patent application Ser. No. 14/317,904, filed Jul. 28, 2014, which in turn is a continuation in part of and claims the benefit of priority to U.S. patent application Ser. No. 14/023,429, filed Sep. 10, 2013, which in turn is a continuation in part of and claims the benefit of priority to U.S. patent application Ser. No. 13/633,866, filed Oct. 2, 2012, which in turn is a continuation of and claims the benefit of priority to U.S. patent application Ser. No. 13/101,334, filed May 5, 2011, which in turn is a continuation-in-part of and claims the benefit of priority to U.S. patent application Ser. No. 12/788,132, filed May 26, 2010, which in turn is a continuation-in-part of and claims the benefit of priority to U.S. patent application Ser. No. 12/649,946, filed Dec. 30, 2009 and issued Sep. 7, 2010 as U.S. Pat. No. 7,788,868, which in turn is a continuation of and claims the benefit of priority to U.S. patent application Ser. No. 12/139,442, filed Jun. 13, 2008 and issued on Feb. 12, 2010 as U.S. Pat. No. 7,654,051, which in turn claims the benefit of priority of U.S. Provisional Patent Application Ser. No. 60/943,692, filed Jun. 13, 2007, and U.S. Provisional Patent Application Ser. No. 61/035,360, filed Mar. 10, 2008.

This patent application is a continuation of and claims the benefit of priority to Ser. No. 16/952,020, filed Nov. 18, 2020, which is a continuation of and claims the benefit of priority to Ser. No. 16/521,246, filed Jul. 24, 2019, which is a continuation of and claims the benefit of priority to U.S. patent application Ser. No. 15/673,651, filed Aug. 10, 2017, which in turn is a continuation of and claims the benefit of priority to U.S. patent application Ser. No. 15/157,749, filed May 18, 2016, which in turn is a continuation of and claims the benefit of priority to U.S. patent application Ser. No. 14/731,103, filed Jun. 4, 2015, which in turn is a continuation in part of and claims the benefit of priority to U.S. patent application Ser. No. 14/317,904, filed Jul. 28, 2014, which in turn is a continuation in part of and claims the benefit of priority to U.S. patent application Ser. No. 14/023,429, filed Sep. 10, 2013, which in turn is a continuation in part of and claims the benefit of priority to U.S. patent application Ser. No. 13/633,866, filed Oct. 2, 2012, which in turn is a continuation of and claims the benefit of priority to U.S. patent application Ser. No. 13/101,334, filed May 5, 2011, which in turn is a continuation-in-part of and claims the benefit of priority to U.S. patent application Ser. No. 12/788,132, filed May 26, 2010, which in turn claims the benefit of priority to U.S. Provisional Patent Application Ser. No. 61/181,125, filed May 27, 2009 and U.S. Provisional Patent Application Ser. No. 61/321,130, filed Apr. 5, 2010.

This patent application is a continuation of and claims the benefit of priority to Ser. No. 16/952,020, filed Nov. 18, 2020, which is a continuation of and claims the benefit of priority to Ser. No. 16/521,246, filed Jul. 24, 2019, which is a continuation of and claims the benefit of priority to U.S. patent application Ser. No. 15/673,651, filed Aug. 10, 2017, which in turn is a continuation of and claims the benefit of priority to U.S. patent application Ser. No. 15/157,749, filed May 18, 2016, which in turn is a continuation of and claims the benefit of priority to U.S. patent application Ser. No. 14/731,103, filed Jun. 4, 2015, which in turn is a continuation in part of and claims the benefit of priority to U.S. patent application Ser. No. 14/317,904, filed Jul. 28, 2014, which in turn is a continuation in part of and claims the benefit of priority to U.S. patent application Ser. No. 14/023,429, filed Sep. 10, 2013, which in turn is a continuation in part of and claims the benefit of priority to U.S. patent application Ser. No. 13/633,866, filed Oct. 2, 2012, which in turn is a continuation of and claims the benefit of priority to U.S. patent application Ser. No. 13/101,334, filed May 5, 2011, which in turn is a continuation-in-part of and claims the benefit of priority to U.S. patent application Ser. No. 12/399,768, filed Mar. 6, 2009, which in turn is a continuation-in-part of and claims benefit of priority from U.S. patent application Ser. No. 11/348,181, filed Feb. 6, 2006 and issued on Mar. 17, 2009 as U.S. Pat. No. 7,503,534, which in turn claims the benefit of priority to U.S. Provisional Patent Application No. 60/650,203, filed Feb. 4, 2005.

This patent application is a continuation of and claims the benefit of priority to Ser. No. 16/952,020, filed Nov. 18, 2020, which is a continuation of and claims the benefit of priority to Ser. No. 16/521,246, filed Jul. 24, 2019, which is a continuation of and claims the benefit of priority to U.S. patent application Ser. No. 15/673,651, filed Aug. 10, 2017, which in turn is a continuation of and claims the benefit of priority to U.S. patent application Ser. No. 15/157,749, filed May 18, 2016, which in turn is a continuation of and claims the benefit of priority to U.S. patent application Ser. No. 14/731,103, filed Jun. 4, 2015, which in turn is a continuation in part of and claims the benefit of priority to U.S. patent application Ser. No. 14/317,904, filed Jul. 28, 2014, which in turn is a continuation in part of and claims the benefit of priority to U.S. patent application Ser. No. 14/023,429, filed Sep. 10, 2013, which in turn is a continuation in part of and claims the benefit of priority to U.S. patent application Ser. No. 13/633,866, filed Oct. 2, 2012, which in turn is a continuation of and claims the benefit of priority to U.S. patent application Ser. No. 13/101,334, filed May 5, 2011, which in turn is a continuation-in-part of and claims the benefit of priority from U.S. patent application Ser. No. 12/819,557, filed Jun. 21, 2010 and issued on Sep. 6, 2011 as U.S. Pat. No. 8,011,903, which in turn is a continuation of and claims the benefit of priority to International Application No. PCT/US2009/038056, filed Mar. 24, 2009, which in turn claims the benefit of priority to U.S. Provisional Patent Application Ser. No. 61/039,429, filed Mar. 26, 2008, and U.S. Provisional Patent Application Ser. No. 61/054,805, filed May 20, 2008.

This patent application is a continuation of and claims the benefit of priority to Ser. No. 16/952,020, filed Nov. 18, 2020, which is a continuation of and claims the benefit of priority to Ser. No. 16/521,246, filed Jul. 24, 2019, which is a continuation of and claims the benefit of priority to U.S. patent application Ser. No. 15/673,651, filed Aug. 10, 2017, which in turn is a continuation of and claims the benefit of priority to U.S. patent application Ser. No. 15/157,749, filed May 18, 2016, which in turn is a continuation of and claims the benefit of priority to U.S. patent application Ser. No. 14/731,103, filed Jun. 4, 2015, which in turn is a continuation in part of and claims the benefit of priority to U.S. patent application Ser. No. 14/317,904, filed Jul. 28, 2014, which in turn is a continuation in part of and claims the benefit of priority to U.S. patent application Ser. No. 14/023,429, filed Sep. 10, 2013, which in turn is a continuation in part of and claims the benefit of priority to U.S. patent application Ser. No. 13/633,866, filed Oct. 2, 2012, which in turn is a continuation of and claims the benefit of priority to U.S. patent application Ser. No. 13/101,334, filed May 5, 2011, which in turn is a continuation-in-part of and claims the benefit of priority from U.S. patent application Ser. No. 12/575,439, filed Oct. 7, 2009 and issued on Aug. 2, 2011 as U.S. Pat. No. 7,987,650, which in turn claims the benefit of priority of U.S. Provisional Patent Application Ser. No. 61/103,613, filed Oct. 8, 2008.

This patent application is a continuation of and claims the benefit of priority to Ser. No. 16/952,020, filed Nov. 18, 2020, which is a continuation of and claims the benefit of priority to Ser. No. 16/521,246, filed Jul. 24, 2019, which is a continuation of and claims the benefit of priority to U.S. patent application Ser. No. 15/673,651, filed Aug. 10, 2017, which in turn is a continuation of and claims the benefit of priority to U.S. patent application Ser. No. 15/157,749, filed May 18, 2016, which in turn is a continuation of and claims the benefit of priority to U.S. patent application Ser. No. 14/731,103, filed Jun. 4, 2015, which in turn is a continuation in part of and claims the benefit of priority to U.S. patent application Ser. No. 14/317,904, filed Jul. 28, 2014, which in turn is a continuation in part of and claims the benefit of priority to U.S. patent application Ser. No. 14/023,429, filed Sep. 10, 2013, which in turn is a continuation in part of and claims the benefit of priority to U.S. patent application Ser. No. 13/633,866, filed Oct. 2, 2012, which in turn is a continuation of and claims the benefit of priority to U.S. patent application Ser. No. 13/101,334, filed May 5, 2011, which in turn is a continuation-in-part of and claims the benefit of priority from U.S. patent application Ser. No. 12/582,748, filed Oct. 21, 2009, which in turn claims the benefit of priority of U.S. Provisional Patent Application Ser. No. 61/107,337, filed Oct. 21, 2008.

This patent application is a continuation of and claims the benefit of priority to Ser. No. 16/952,020, filed Nov. 18, 2020, which is a continuation of and claims the benefit of priority to Ser. No. 16/521,246, filed Jul. 24, 2019, which is a continuation of and claims the benefit of priority to U.S. patent application Ser. No. 15/673,651, filed Aug. 10, 2017, which in turn is a continuation of and claims the benefit of priority to U.S. patent application Ser. No. 15/157,749, filed May 18, 2016, which in turn is a continuation of and claims the benefit of priority to U.S. patent application Ser. No. 14/731,103, filed Jun. 4, 2015, which in turn is a continuation in part of and claims the benefit of priority to U.S. patent application Ser. No. 14/317,904, filed Jul. 28, 2014, which in turn is a continuation in part of and claims the benefit of priority to U.S. patent application Ser. No. 14/023,429, filed Sep. 10, 2013, which in turn is a continuation in part of and claims the benefit of priority to U.S. patent application Ser. No. 13/633,866, filed Oct. 2, 2012, which in turn is a continuation of and claims the benefit of priority to U.S. patent application Ser. No. 13/101,334, filed May 5, 2011, which in turn is a continuation-in-part of and claims the benefit of priority from U.S. patent application Ser. No. 12/823,948, filed Jun. 25, 2010.

This patent application is a continuation of and claims the benefit of priority to Ser. No. 16/952,020, filed Nov. 18, 2020, which is a continuation of and claims the benefit of priority to Ser. No. 16/521,246, filed Jul. 24, 2019, which is a continuation of and claims the benefit of priority to U.S. patent application Ser. No. 15/673,651, filed Aug. 10, 2017, which in turn is a continuation of and claims the benefit of priority to U.S. patent application Ser. No. 15/157,749, filed May 18, 2016, which in turn is a continuation of and claims the benefit of priority to U.S. patent application Ser. No. 14/731,103, filed Jun. 4, 2015, which in turn is a continuation in part of and claims the benefit of priority to U.S. patent application Ser. No. 14/317,904, filed Jul. 28, 2014, which in turn is a continuation in part of and claims the benefit of priority to U.S. patent application Ser. No. 14/023,429, filed Sep. 10, 2013, which in turn is a continuation in part of and claims the benefit of priority to U.S. patent application Ser. No. 13/844,776, filed Mar. 15, 2013, which in turn is a continuation in part of and claims the benefit of priority to U.S. patent application Ser. No. 13/633,866, filed Oct. 2, 2012, which in turn is a continuation of and claims the benefit of priority to U.S. patent application Ser. No. 13/101,334, filed May 5, 2011, which in turn is a continuation-in-part of and claims the benefit of priority from U.S. patent application Ser. No. 12/823,948, filed Jun. 25, 2010.

This patent application is a continuation of and claims the benefit of priority to Ser. No. 16/952,020, filed Nov. 18, 2020, which is a continuation of and claims the benefit of priority to Ser. No. 16/521,246, filed Jul. 24, 2019, which is a continuation of and claims the benefit of priority to U.S. patent application Ser. No. 15/673,651, filed Aug. 10, 2017, which in turn is a continuation of and claims the benefit of priority to U.S. patent application Ser. No. 15/157,749, filed May 18, 2016, which in turn is a continuation of and claims the benefit of priority to U.S. patent application Ser. No. 14/731,103, filed Jun. 4, 2015, which in turn is a continuation in part of and claims the benefit of priority to U.S. patent application Ser. No. 14/317,904, filed Jul. 28, 2014, which in turn is a continuation in part of and claims the benefit of priority to U.S. patent application Ser. No. 14/023,429, filed Sep. 10, 2013, which in turn is a continuation in part of and claims the benefit of priority to U.S. patent application Ser. No. 13/633,866, filed Oct. 2, 2012, which in turn is a continuation of and claims the benefit of priority to U.S. patent application Ser. No. 13/101,334, filed May 5, 2011, which in turn is a continuation-in-part of and claims the benefit of priority from U.S. patent application Ser. No. 12/723,185, filed Mar. 12, 2010 and issued on Sep. 6, 2011 as U.S. Pat. No. 8,011,151, which in turn claims the benefit of priority of U.S. Provisional Patent Application Ser. No. 61/159,776, filed Mar. 12, 2009.

This patent application is a continuation of and claims the benefit of priority to Ser. No. 16/952,020, filed Nov. 18, 2020, which is a continuation of and claims the benefit of priority to Ser. No. 16/521,246, filed Jul. 24, 2019, which is a continuation of and claims the benefit of priority to U.S. patent application Ser. No. 15/673,651, filed Aug. 10, 2017, which in turn is a continuation of and claims the benefit of priority to U.S. patent application Ser. No. 15/157,749, filed May 18, 2016, which in turn is a continuation of and claims the benefit of priority to U.S. patent application Ser. No. 14/731,103, filed Jun. 4, 2015, which in turn is a continuation in part of and claims the benefit of priority to U.S. patent application Ser. No. 14/317,904, filed Jul. 28, 2014, which in turn is a continuation in part of and claims the benefit of priority to U.S. patent application Ser. No. 14/023,429, filed Sep. 10, 2013, which in turn is a continuation in part of and claims the benefit of priority to U.S. patent application Ser. No. 13/633,866, filed Oct. 2, 2012, which in turn is a continuation of and claims the benefit of priority to U.S. patent application Ser. No. 13/101,334, filed May 5, 2011, which in turn is a continuation-in-part of and claims the benefit of priority from U.S. patent application Ser. No. 12/749,358, filed Mar. 29, 2010, which in turn claims the benefit of priority of U.S. Provisional Patent Application Ser. No. 61/164,424, filed Mar. 29, 2009.

This patent application is a continuation of and claims the benefit of priority to Ser. No. 16/952,020, filed Nov. 18, 2020, which is a continuation of and claims the benefit of priority to Ser. No. 16/521,246, filed Jul. 24, 2019, which is a continuation of and claims the benefit of priority to U.S. patent application Ser. No. 15/673,651, filed Aug. 10, 2017, which in turn is a continuation of and claims the benefit of priority to U.S. patent application Ser. No. 15/157,749, filed May 18, 2016, which in turn is a continuation of and claims the benefit of priority to U.S. patent application Ser. No. 14/731,103, filed Jun. 4, 2015, which in turn is a continuation in part of and claims the benefit of priority to U.S. patent application Ser. No. 14/317,904, filed Jul. 28, 2014, which in turn is a continuation in part of and claims the benefit of priority to U.S. patent application Ser. No. 14/023,429, filed Sep. 10, 2013, which in turn is a continuation in part of and claims the benefit of priority to U.S. patent application Ser. No. 13/633,866, filed Oct. 2, 2012, which in turn is a continuation of and claims the benefit of priority to U.S. patent application Ser. No. 13/101,334, filed May 5, 2011, which in turn claims the benefit of priority of U.S. Provisional Patent Application Ser. No. 61/345,144, filed May 16, 2010, U.S. Provisional Patent Application Ser. No. 61/332,756, filed May 8, 2010, U.S. Provisional Patent Application Ser. No. 61/332,141, filed May 6, 2010, U.S. Provisional Patent Application Ser. No. 61/390,915, filed Oct. 7, 2010, U.S. Provisional Patent Application Ser. No. 61/412,958, filed Nov. 12, 2010, U.S. Provisional Patent Application Ser. No. 61/445,631, filed Feb. 23, 2011, and U.S. Provisional Patent Application Ser. No. 61/418,456, filed Dec. 1, 2010.

This patent application is a continuation of and claims the benefit of priority to Ser. No. 16/952,020, filed Nov. 18, 2020, which is a continuation of and claims the benefit of priority to Ser. No. 16/521,246, filed Jul. 24, 2019, which is a continuation of and claims the benefit of priority to U.S. patent application Ser. No. 15/673,651, filed Aug. 10, 2017, which in turn is a continuation of and claims the benefit of priority to U.S. patent application Ser. No. 15/157,749, filed May 18, 2016, which in turn is a continuation of and claims the benefit of priority to U.S. patent application Ser. No. 14/731,103, filed Jun. 4, 2015, which in turn is a continuation in part of and claims the benefit of priority to U.S. patent application Ser. No. 14/317,904, filed Jul. 28, 2014, which in turn is a continuation in part of and claims the benefit of priority to U.S. patent application Ser. No. 14/023,429, filed Sep. 10, 2013, which in turn claims the benefit of priority to U.S. Provisional Patent Application Ser. No. 61/699,253, filed Sep. 10, 2012, U.S. Provisional Patent Application Ser. No. 61/734,966, filed Dec. 8, 2012, U.S. Provisional Patent Application Ser. No. 61/748,533, filed Jan. 3, 2013 and U.S. Provisional Patent Application Ser. No. 61/751,867, filed Jan. 12, 2013.

This patent application is a continuation of and claims the benefit of priority to Ser. No. 16/952,020, filed Nov. 18, 2020, which is a continuation of and claims the benefit of priority to Ser. No. 16/521,246, filed Jul. 24, 2019, which is a continuation of and claims the benefit of priority to U.S. patent application Ser. No. 15/673,651, filed Aug. 10, 2017, which in turn is a continuation of and claims the benefit of priority to U.S. patent application Ser. No. 15/157,749, filed May 18, 2016, which in turn is a continuation of and claims the benefit of priority to U.S. patent application Ser. No. 14/731,103, filed Jun. 4, 2015, which in turn is a continuation in part of and claims the benefit of priority to U.S. patent application Ser. No. 14/317,904, filed Jul. 28, 2014, which in turn claims the benefit of priority to U.S. Provisional Patent Application Ser. No. 61/876,219, filed Sep. 10, 2013, U.S. Provisional Patent Application Ser. No. 61/888,795, filed Oct. 9, 2013, U.S. Provisional Patent Application Ser. No. 61/930,937, filed Jan. 23, 2014 and U.S. Provisional Patent Application Ser. No. 61/930,944, filed Jan. 23, 2014 and U.S. Provisional Patent Application Ser. No. 61/930,954, filed Jan. 24, 2014.

This patent application is a continuation of and claims the benefit of priority to Ser. No. 16/952,020, filed Nov. 18, 2020, which is a continuation of and claims the benefit of priority to Ser. No. 16/521,246, filed Jul. 24, 2019, which is a continuation of and claims the benefit of priority to U.S. patent application Ser. No. 15/673,651, filed Aug. 10, 2017, which in turn is a continuation of and claims the benefit of priority to U.S. patent application Ser. No. 15/157,749, filed May 18, 2016, which in turn is a continuation of and claims the benefit of priority to U.S. patent application Ser. No. 14/731,103, filed Jun. 4, 2015, which in turn claims the benefit of priority to U.S. Provisional Patent Application Ser. No. 62/023,218, filed Jul. 11, 2014, U.S. Provisional Patent Application Ser. No. 62/035,099, filed Aug. 8, 2014, U.S. Provisional Patent Application Ser. No. 62/112,157, filed Feb. 4, 2015, and U.S. Provisional Patent Application Ser. No. 62/118,881, filed Feb. 9, 2015.

This patent application is also related to U.S. Provisional Patent Application Ser. No. 61/317,271, filed Mar. 24, 2010 and U.S. Provisional Patent Application Ser. No. 61/310,383, filed Mar. 4, 2010. The disclosure of each and every patent application referenced herein and above is incorporated by reference herein in its entirety for any purpose whatsoever.

### BACKGROUND OF THE DISCLOSURE

### Field of the Disclosure

The present invention relates to a methods, systems and machine readable programs for improving selection of clothing. Particularly, the present disclosure is directed to methods, systems and machine readable programs for improving the fit and appearance in selection of clothing.

### Description of Related Art

Clothing selection involves several factors, such as type, style and fit. Much of the clothing purchased in mail order catalogs, on the internet, as well as in retail stores is returned due to dissatisfaction with sizing. It is not uncommon for a purchaser of a garment to return the garment more than two times before keeping one, and possibly settling for proportions that are less than preferred. Many approaches have been proposed to improve the fit of garments by engaging in three-dimensional scanning of a user to determine the “size” of the user. The user can then order a custom garment based on the scan data, or is then informed as to the user's actual “size” permitting the user to go shopping. However, this approach is not especially helpful for buying clothes “off the rack” or online from a catalog where the clothes are pre-manufactured into predetermined sizes. A significant culprit that exacerbates this problem is that the cut of a given article of clothing, depending on its style can affect its true size. Also, sizes tend to vary by manufacturer, and no objective universal standard is in place that can normalize all clothing sizes. The present disclosure provides solutions for these and other problems, as set forth below.

### SUMMARY OF THE DISCLOSURE

The purpose and advantages of the present disclosure will be set forth in and become apparent from the description that follows. Additional advantages of the disclosed embodiments will be realized and attained by the methods and systems particularly pointed out in the written description hereof, as well as from the appended drawings.

The present disclosure is directed to mitigating dissatisfaction that purchasers of clothing have with the fit of clothing and apparel. Systems made and methods implemented in accordance with the subject disclosure help alleviate these and other problems in the art. For example, clothing types such as under garments, sportswear, casual wear, formal clothing, tailored dresses and men's suits and over garments (e.g., jackets and coats) can be categorized with the disclosed exemplary systems to facilitate better sizing and result in better customer satisfaction. Accordingly, the disclosed embodiments facilitate obtaining an optimal fit for clothing, and will thus facilitate reduction of returns due to poor fit. In accordance with another aspect, the disclosed embodiments will permit the creation of other points of clothing measurement of merit to help improve the fit, and appearance and performance of clothing. In accordance with still a further aspect, the disclosed embodiments can help establish a truly uniform methodology for sizing clothing that apparel manufacturers can use in designing clothing. In one aspect, the disclosed embodiments relate to a measuring system and a data handling system that can be contained in one or a plurality of data locations, as well as being in the possession of the person that has been measured for clothing size.

In accordance with another aspect, the measuring system can use a body suit (such as a body sock) to help ascertain a person's three dimensional profile (that is to say, a three-dimensional map of the user's surface area) made, for example, from elastic fabric such as “Lycra®” or Nylon having a plurality of markers, which may be reflective “dots” “reflectors” or other particles attached to, and essentially evenly distributed across the surface of the body suit. In accordance with an alternative embodiment, three-dimensional laser scanning as known in the art can be used to obtain a three dimensional profile for a subject user. In accordance with use of a three-dimensional laser scanner, if desired, the wearer may use a closely fitting outfit (e.g., a body sock or running suit) to facilitate taking the clothing measurement, and to help preserve the modesty of the wearer. The suit is preferably made from a material or modified to include a material to facilitate the laser scanning measurement. Additionally or alternatively, the user may be spray-coated with a substance that facilitates such measurement.

If metal particles are used, they may be woven into the fabric, or attached with adhesive, or sewn or otherwise attached to the surface in a manner that does not injure the wearer or result in his or her discomfort even if worn all day. A three dimensional scanner can then be used to create a measurable image of the wearer of the “sock” and measure critical dimensions at vital points of the wearer's anatomy. The image and measured data can then be written to media such as a compact disc, as well at being sent to the central information locations. The information can then be identified, for example, by name, residence address, telephone number and or e-mail address. The last 4 digits of the individual's social security number or a separate unique ID number (e.g., pin number) can also be used, if desired.

The scanning devices can be located at participating merchants, such as department stores, or at measuring stations connected with the system. They are preferably conveniently located for access to any potential participant. The user can be re-scanned if it is suspected that any of the dimensions might have changed as due to normal growth as with children, and if weight has been gained or lost by the user.

The “sock” can be purchased as a one time charge and kept over the years for sizing purposes. An entire family of similarly-sized individuals can share it for the occasional ritual of being re-measured. Body suits can be provided for any user's size, such as children. In accordance with a further embodiment, such a body sock can be used for a pet (e.g., dogs, etc.) to permit sizing of appropriate garments therefor. In any event, when the data is created, the user can be given a magnetic or optical copy as a record. This measurement can be done at a nominal charge. The system can also be supported by the merchant users who will benefit from a reduced number of returns.

Additionally, other information can be incorporated into the user's data such as color preferences and the type of fit the user desires. For example, one individual might prefer a very tailored look while someone else prefers a looser or more casual fit. The size of choice can be altered slightly with those choices taken into consideration by a computer that processes the information. The body sock, if used, preferably clings tightly to the user during measuring and an operator of the scanner system can examine the user prior to scanning to insure there is no “bagging”, the “sock” can also be worn under a person's outer garments so that no changing of garments is be required at the scanning location. A sock is preferably used as it can smooth out uneven contours in a user's anatomy that can otherwise be smoothed out by clothing (e.g., in the waist region or other regions where adipose tissue tends to deposit). This can permit measurement of the size of an individual that accounts for how the user's anatomy distorts when the user actually wears clothing, which is highly advantageous.

If desired, a 3-D image can also be provided for the user's face and head. A feature of the system may reside in the ability of the user to actually see himself or herself in a virtual garment (on a computer) with the precise scanned dimensions and proportions of the user's physique.

An additional advantage to the exemplary system is that a purchaser, other than the user, for example a relative or friend, wishing to order a gift to be shipped to the user, can order a size that will fit the recipient well. The purchaser can be provided with certain vital information regarding the identity of the user (by way of providing a file to the purchaser directly by the recipient, or the recipient can simply publish such information online, such as in Facebook® applications or other similar online applications, and give certain classes of persons permissions to view or otherwise access such information). This information can then be conveyed to the company along from which the clothing purchase is to be made along with the shipping information. The system at the end of the clothing company can then key the order to that person's sizing information.

In accordance with a further aspect, at the manufacturer's end of the system, a similar “sock” can be employed to permit the manufacturer to standardize its product line to a standard measurement system. Rather than using the disclosed embodiments to only provide a basis for custom clothing (although this is possible), in accordance with a preferred embodiment, it is desired for the disclosed system to provide a foundational framework for existing, standard clothing that: (i) characterizes the size and contours of an individual, and (ii) characterizes the “real” sizes of the clothing of manufacturers by placing a manufacturer's existing inventory on a mannequin or model that has been measured in accordance with the teachings herein to permit the “real” size of the wearer to be matched (as closely as possible) with the “real” sizes and proportions of a manufacturer's clothing. Accordingly, at the manufacturer end, the disclosed body suit is preferably disposed about an inflatable mannequin that can be inflated inside of the clothing until the clothing is filled. The pressure of inflation of the mannequin can be recorded, and the mannequin can be re-inflated without the clothing present to determine the proper “size.” Preferably, the inflatable mannequin is robust and its inflation characteristics is not significantly affected by being placed inside an article of clothing. As will be appreciated, several mannequins of differing heights and basic body types for both sexes (e.g. ectomorphic, mesomorphic and endomorphic types, as well as categories falling between these categories) can be used.

As an example, if the garment of interest is a pair of pants, the manufacturer can slip a pair of a certain “lot” or “run” of pants over an inflatable partial mannequin. The mannequin can then be inflated to a point where the pants are a suitable fit on the mannequin. The pressure can then be recorded, the mannequin can then be deflated, the pants removed, then the mannequin can then be reinflated and scanned to obtain the proper size. The scanned information can then be translated, for example, into a UPC coding and the garments tagged accordingly. A “run” of clothing should be checked for consistency and it is possible that a different “run” of the same size might have slightly different vital statistics. These differences can be noted in the memory system, such as part of a quality control process, and a the data handler might choose one pair of pants over another of the same size as it matches the user's scanned statistics more suitably. As will be appreciated, this may reduce the amount of waste at the manufacturer, as an article of clothing that might be off-specification for one size can turn out to be suitable for the next size up or the next size down.

Since the basis for fit in accordance with the present disclosure is preferably a 3-D model, the number of dimensions used to size an individual and/or article of clothing might be considerably greater than those presently employed in the garment industry. For example, currently, trousers are categorized with waist, inseam and designations such as “portly” and “regular”. With this system, additional measurements such as pant leg diameter, the distance from top of belt to crotch, and proportions of the backside can further enhance a proper fit, among other dimensions. Generally, sizing can be based, for example, on the circumferences of body parts (e.g., limbs, trunk, neck, etc) in combination with approximate distance between joints (e.g., ankle to knee; knee to hip; hip to shoulder and the like).

It will also be appreciated that the subject disclosure may also be applied to footwear, such as boots, shoes and the like. Separate 3-D scanning can be performed on feet using a smaller scanning device and a sock with metal particles or with a laser scanner. It is believed that a plurality of fine measurements of the foot and related measurements in footwear can result in a similar sizing benefit.

In accordance with a further embodiment, it is possible to perform body scans of a user in different positions such as standing, and sitting. Clothing can be sized onto models and/or mannequins to provide similar comparative data for sizing. By way of further example, motion can also be incorporated in the scanning process including such activities as walking, sitting and standing. It is believed that this can be useful for illustration of the user in a particular garment with facial information, etc., allowing the user to view his or her appearance in motion if the user is contemplating purchase of a garment, for example, over the Internet in accordance with the disclosed system and methods.

A UPC-based (barcode-based) method of encoding preferred dimensional data can be used. By way of further example, possible measurements which can be identified are: neck diameter, shoulder width, sleeve length, sleeve diameter, collar to waist, girth of chest, girth of waist, girth of hips, backside proportions, length from waist to bottom or cuff, girth of leg at thigh and calf and inseam, as well as other points which may be pertinent in certain clothing items. Software can be downloaded onto a user's computer on a form of readable media (e.g., disk or flash drive) that can be contained on the record disc with the sizing information. Use of this system will preferably reduce returns due to poorly fitting clothing. Additionally, apparel manufacturers can include additional measuring points with no additional cost.

It is to be understood that both the foregoing general description and the following detailed description are exemplary and are intended to provide further explanation of the embodiments disclosed herein.

The accompanying drawings, which are incorporated in and constitute part of this specification, are included to illustrate and provide a further understanding of the methods and systems of the disclosure. Together with the description, the drawings serve to explain the principles of the disclosed embodiments.

### BRIEF DESCRIPTION OF THE DRAWINGS

FIG. 1 illustrates exemplary “body sock” to be worn by a user of an embodiment of the disclosed system.

FIG. 2 illustrates an exemplary inflatable mannequin to be used in sizing runs of apparel in various sizes. In this example, it illustrates a device for measuring trousers.

FIG. 3 illustrates a schematic diagram of the system in accordance with the disclosure.

FIG. 4 illustrates a suggestion of a possible scanner assembly. It should be noted that there are existing 3-D scanning devices of different configurations which can be adapted for this function.

### DETAILED DESCRIPTION OF THE DRAWINGS

Reference will now be made in detail to the present preferred embodiments of the disclosure, examples of which are illustrated in the accompanying drawings. The method and corresponding steps of the disclosed embodiments will be described in conjunction with the detailed description of the system.

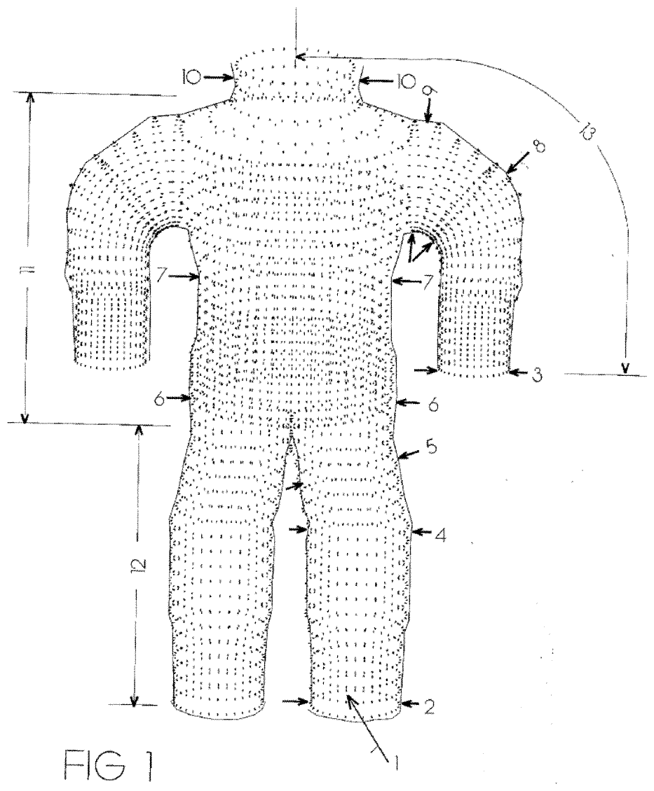

FIG. 1 illustrates an exemplary elastic “body sock.” Such an article can be put on by a user in a changing booth at a scanning location, or it can be worn under the user's clothing. No. 1 points to the “body sock”. No. 2 indicates the dimension of the users leg size at the top of the ankle. In this location, the actual garment, trousers, may measure a substantially greater dimension. The increases from those measured will be determined by style, function, and choice of fit. In the instance of men's trousers, the usual dimension of the garment can be, for example, three times that of the user's measured dimension. In the case of women's Toreador-style pants, the measured user's dimension can be very close to the dimension of the garment. The measurement at 2 can, if desired, actually be two dimensions measuring the width and the depth at that location. No. 3 indicates the measurement at the wrists, which can also include the depth as well as the width. No. 4 indicates the diameter at the knees, 5 at the thigh, 6 at the waist, 7 at the chest, 8 at the elbow, 9 at the upper arm or shoulder and 10 at the neck. These dimensions can, if desired, all include a depth measurement as well. Additional measurements can include 11 from the neck to the waist, 12, the inseam, and 13 indicating the sleeve length. The ease of obtaining such measurements can permit additional criteria for a superior fit such as for men's suits and other formal wear.

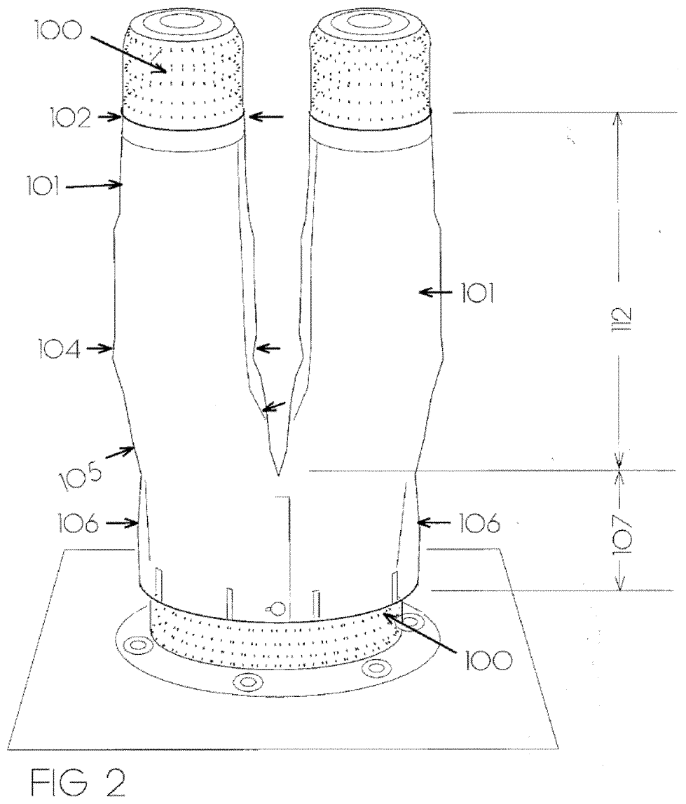

FIG. 2 illustrates an exemplary inflatable device similar to the “body sock” for scanning clothing in order to classify garments within the sizing system. In this instance, an inflatable bladder in the configuration of the lower portion of a human torso is provided for the sizing of various styles of garments of the trouser category, such as bell-bottomed, cuffed, or slack trousers, culottes, skin-hugging styles, shorts and other garments of this type. No. 100 indicates the bladder, which is sized to accommodate all anticipated lengths of trousers. No. 101 points to the garment being measured. Nos. 102 to 106 indicate measurement locations which may involve width and depth measurements. 107 and 112 indicate the waistband to crotch and inseam measurements respectively. Additional criteria can be identified for close fitting garments. The garment being measured, 101, is preferably a representative example of any lot of a certain size of the particular article. The manufacturer or measuring agent is preferably confident that the sample being measured is representative of the other garments in the lot. This can be better insured by the measurement of random additional garments in the same lot.

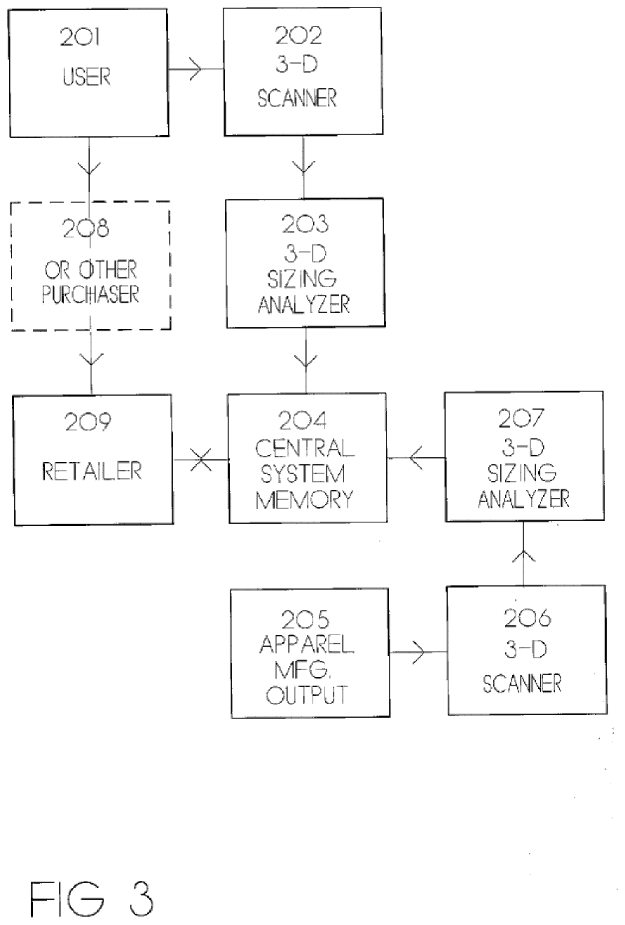

FIG. 3 is a schematic diagram of an exemplary embodiment of the system. No. 201 represents the user; 202 the scanner located at a retailer or vendor involved with the system. No. 203 is the analyzer which can be located with the scanner, or, for example, at a central database. No. 204 is an exemplary central system memory which can be in the form of a server farm or can be at a plurality of interlinked locations. No. 205 is the clothing source, which can be an apparel manufacturer, an importer, or a wholesaler. 206 is the garment scanner which is preferably at the location of 205. No. 207 is the processor or analyzer which may be at the scanner 206 location or at the central memory location, 204. No. 201, the user, or 208, another purchaser, can contact the retailer, whether a department store, a catalog merchant or over the internet. The purchaser, whether the user 201, or someone sending a gift to the user 208, supplies the retailer 209 with an identifier, whether the user's name, address and telephone number, or a coded identifier which can be supplied to relatives and friends, along with the clothing selection and be certain of a good fit.

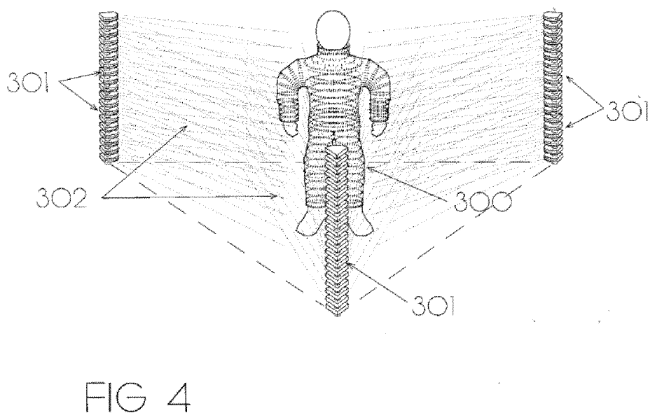

FIG. 4 is a conceptual view of a scanner installation which can, for example, be placed in a room or booth off of the selling floor of a retail store, or in the space of a private vendor, providing the service for a fee, if desired. No. 300 is the user wearing the “body sock” over or under street clothes. No. 301 indicates the scanning horn tower arrays. No. 302 indicates scanning rays emanating from the scanning heads. It would be the responsibility of the user to be re-scanned if the user suspects he or she has gained or lost weight or otherwise had measurement changes.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Block diagrams and other representations of circuitry herein represent conceptual views of illustrative circuitry and software embodying the principles of the disclosure. Thus the functions of the various elements shown in the Figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. The functions of those various elements may be implemented by, for example, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The disclosure as defined by such elements resides in the fact that the functionalities provided by the various recited means are combined and brought together in the manner which the disclosure calls for. Applicant thus regards any means which can provide those functionalities as equivalent to those shown herein.

Similarly, it will be appreciated that the system flows described herein represent various processes which may be substantially represented in computer-readable medium and so executed by a computer or processor, whether or not such computer or processor is explicitly shown. Moreover, the various processes can be understood as representing not only processing and/or other functions but, alternatively, as blocks of program code that carry out such processing or functions.

The methods and systems of the present disclosure, as described above and shown in the drawings, provide for a clothing fitting system with superior properties. It will be apparent to those skilled in the art that various modifications and variations can be made in the systems and methods of the present disclosure without departing from the spirit or scope of the disclosure. Thus, it is intended that the present disclosure include modifications and variations that are within the scope of the subject disclosure and equivalents.

What is claimed is:

1. A method of remotely determining a user's clothing size, comprising:
receiving image data of a user, wherein the image data is obtained by optically imaging the user when the user wears tight fitting clothing to conform to the user's body;
analyzing the image data; and
determining at least one article of clothing that is likely to fit the user.
